(19) United States
(12) Patent Application Publication
(10) Pub. No.: US 2009/0127842 A1
(43) Pub. Date: May 21, 2009

(54) NOTEBOOK BINDER SPACER

(76) Inventor: ArLean Minnick, Sedona, AZ (US)

Correspondence Address: BOOTH UDALL, PLC, 1155 W. Rio Salado Pkwy., Suite 101, Tempe, AZ, 85281, US

(21) Appl. No.: 12/120,519

(22) Filed: May 14, 2008

Related U.S. Application Data
(60) Provisional application No. 60/988,221, filed on Nov. 15, 2007.

(51) Int. Cl. B42D 12/00

(52) U.S. Cl. 281/15.1

(57) ABSTRACT

A spacer for use with a notebook binder and methods of use are described. An implementation of a notebook spacer may comprise a first panel, a second panel and an end panel each comprising a top edge, a bottom edge, an exterior surface, and an interior surface. The top edge of the first panel is coupled with the top edge of the end panel, forming a first interior angle and a first exterior angle; the top edge of the second panel is coupled with the bottom edge of the end panel, forming a second interior angle and a second exterior angle; and the interior surfaces of the first panel, second panel and end panel define a wedge-shaped area comprising the first interior angle and second interior angle, wherein the first interior angle and second interior angle are supplementary to the first exterior angle and second exterior angle, respectively.

### CROSS REFERENCE TO RELATED APPLICATIONS

This document claims the benefit of the filing date of commonly owned U.S. Provisional Patent Application 60/988,221, entitled “NOTEBOOK BINDER SPACER . . . ” to Minnick which was filed on Nov. 15, 2007, the contents of which are hereby incorporated herein by reference.

### BACKGROUND

1. Technical Field

Aspects of this document relate generally to notebook binder spacers.

2. Background Art

Notebook binders and similar devices, sometimes called loose-leaf binders, 3-ring binders, 4-ring binders, 5-ring binders, or notebooks, are known in the art. Such notebook binders typically comprise a “spine” element sometimes comprising a label or other identification information, two covers that are hingedly coupled with the spine and one or more openable rings coupled with the spine which fit through one or more corresponding holes punched into the loose leaf sheets, thereby securing the loose leaf sheets with respect to the notebook binder.

When conventional binders are maintained in a closed position, their shape, when viewed from the top or bottom, can best be described as cuneiform. If a binder is not full of loose leaf sheets, a wedge may be formed with the spine forming the widest part, tapering to somewhat of a point where the two cover edges that are not coupled with the spine converge. When stacking such notebook binders, either by stacking one on top of another, or shelving side-by-side, the wedge-shaped configuration may present difficulties. In particular, binders that are stacked one upon another without alternating the orientation of the widest part of the wedge may form an unstable stack, which may easily fall or slide. In addition, alternating the widest part of the wedges formed by notebook binders when stacking them one on top of another, while providing a more stable stack, may nevertheless obscure the spine of one or more binders, which may in turn obscure a label or other identification information. Additional difficulties may attend the shelving of notebook binders side-by-side. In particular, when numerous notebook binders are shelved side-by-side, the difference between the width at the spine and the width where the two cover edges that are not coupled with the spine converge may cause the spines to begin to “splay.” Specifically, when numerous notebook binders are shelved side-by-side, the spines may not be maintained substantially parallel to one another, thereby forming a substantially straight line, but may rather form a substantially curvilinear line.

Since notebook binders find common usage in business, education and the home, and since notebook binders are not always full of papers such that the covers maintain a substantially parallel configuration to one another, and in light of the difficulties associated with stacking and shelving notebook binders, there exists a clear need to allow for easy stacking and shelving of notebook binders.

### SUMMARY

Aspects of this document relate to notebook binder spacers.

In one aspect, a spacer for use with a notebook binder comprises a first panel comprising a top edge, a bottom edge, an exterior surface, and an interior surface; a second panel comprising a top edge, a bottom edge, an exterior surface; and an interior surface is provided. An end panel comprising a top edge, a bottom edge, an exterior surface and an interior surface is also provided. The top edge of the first panel is coupled with the top edge of the end panel, forming a first interior angle and a first exterior angle. The top edge of the second panel is coupled with the bottom edge of the end panel, forming a second interior angle and a second exterior angle. The interior surfaces of the first panel, second panel and end panel define a wedge-shaped area comprising the first interior angle and second interior angle, wherein the first interior angle and second interior angle are supplementary to the first exterior angle and second exterior angle, respectively.

Particular implementations may include one or more of the following. The first panel of the spacer may be coupled with one of: a front cover and a rear cover of a notebook binder. The first panel of the spacer may be integral with one of: a front cover and a rear cover of a notebook binder. The second panel of the spacer may be coupled with one of: a front cover and a rear cover of a notebook binder. The second panel of the spacer may be integral with one of: a front cover and a rear cover of a notebook binder. The bottom edge of the second panel may be coupled with the bottom edge of the first panel. The bottom edge of the second panel may be coupled with the interior surface of the first panel.

In another aspect, a spacer for use with a notebook binder comprises a first panel comprising a top edge, a bottom edge, an exterior surface, and an interior surface; a second panel comprising a top edge, a bottom edge, an exterior surface, and an interior surface. The top edge of the first panel is coupled with the top edge of the second panel, forming a first interior angle and a first exterior angle. The bottom edge of one of the first panel and the second panel is coupled with one of a front cover and a rear cover of a notebook binder, forming a second interior angle and a second exterior angle. The interior surfaces of the first panel and the second panel and one of the front cover and the rear cover of the notebook binder define a wedge-shaped area comprising the first interior angle and second interior angle, wherein the first interior angle and second interior angle are supplementary to the first exterior angle and second exterior angle, respectively.

Particular implementations may include one or more of the following. The top edge of the first panel may be coupled with the top edge of the second panel via a hinge element. The bottom edge of the first panel may be coupled with one of a front cover and a rear cover of a notebook binder via a hinge element. The bottom edge of the second panel may be coupled with one of the front cover and the rear cover of the notebook binder.

In still another aspect, a method of vertically or horizontally stacking notebook binders using a spacer comprises placing a first notebook binder on one of a front cover, a rear cover, a top end, a bottom end, a front edge, and a spine. The method further comprises placing one of a first panel and a second panel of a spacer in communication with one of the front cover, the rear cover, the top end, the bottom end, the front edge, and the spine of the first notebook binder. The method still further comprises placing a second notebook binder, different from the first notebook binder, on one of a front cover, a rear cover, a top end, a bottom end, a front edge, and a spine, with one of the front cover and the rear cover of the second notebook binder in communication with one of the first panel and the second panel of the spacer.

Particular implementations may include one or more of the following. Placing one of a first panel and a second panel of a spacer in communication with one of the front cover, the rear cover, the top end and the bottom end of the first notebook spacer may comprise first adjusting an area between the first panel and the second panel of the spacer.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The invention will hereinafter be described in conjunction with the appended drawings, where like designations denote like elements, and:

FIG. 1 is a top view of prior art shelved notebook binders;

FIG. 2 is a end view of prior art stacked notebook binders;

FIG. 3 is a cut-away view of prior art boxed notebook binders;

FIG. 4 is a top view of a notebook binder spacer;

FIG. 5 is a bottom view of a notebook binder spacer;

FIG. 6 is a front perspective view of a notebook binder spacer;

FIG. 7 is a rear perspective view of a notebook binder spacer;

FIG. 8 is a top view of shelved notebook binders with spacers;

FIG. 9 is an end view of stacked notebook binders with spacers;

FIG. 10 is a cut-away view of boxed notebook binders with spacers.

### DESCRIPTION

It will be understood that notebook binder spacer implementations are not limited to the specific assemblies, devices and components disclosed in this document, as virtually any assemblies, devices and components consistent with the intended operation of a notebook binder spacer implementation may be utilized. Accordingly, for example, although particular spacers, first panels, second panels, end panels, top edges, bottom edges, interior angles, exterior angles, wedge-shaped areas, and other assemblies, devices and components are disclosed, such may comprise any shape, size, style, type, model, version, measurement, concentration, material, quantity, and/or the like as is known in the art for such notebook binder spacers and implementing components, consistent with the intended operation thereof. Implementations are not limited to uses of any specific assemblies, devices and components; provided that the assemblies, devices and components selected are consistent with the intended operation of a notebook binder spacer and system implementation. In addition, there are many features of notebook binder spacers disclosed herein, of which one, a plurality, or all features may be used in any particular implementation.

Implementations of notebook binder spacer and implementing components may be constructed of a wide variety of materials. For example, the components may be formed of: polymers such as thermoplastics (such as Acrylic, Polypropylene, ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; glasses (such as fiberglass), carbon-fiber, aramid-fiber, any combination thereof, and/or other like materials; paper and/or cardboard or the like; composites and/or other like materials; metals, such as zinc, magnesium, titanium, copper, lead, iron, steel, carbon steel, alloy steel, tool steel, stainless steel, brass, tin, antimony, aluminum, any combination thereof, and/or other like materials; alloys, such as aluminum alloy, titanium alloy, magnesium alloy, copper alloy, any combination thereof, and/or other like materials; any other suitable material; and/or any combination of the foregoing thereof. For the exemplary purposes of this disclosure, components of a notebook binder spacer may comprise a plastic material like acrylic.

Some components defining a notebook binder spacer implementations may be manufactured simultaneously and integrally joined with one another, while other components may be purchased pre-manufactured or manufactured separately and then assembled with the integral components. Various implementations may be manufactured using conventional procedures as added to and improved upon through the procedures described here.

Accordingly, manufacture of these components separately or simultaneously may involve injection molding, vacuum forming, blow molding, extrusion, casting, forging, cold rolling, milling, drilling, reaming, turning, grinding, stamping, pressing, cutting, bending, welding, soldering, hardening, riveting, punching, plating, and/or the like. Components manufactured separately may then be coupled or removably coupled with the other integral components in any manner, such as with adhesive, a heat weld, a weld joint, a solder joint, a fastener (e.g. a bolt and a nut, a screw, a rivet, a pin, and/or the like), washers, retainers, wrapping, wiring, any combination thereof, and/or the like for example, depending on, among other considerations, the particular material forming the components.

It has been determined that when shelving notebook binders on a shelf, desk, table or other horizontally planar surface, it is desirable to arrange the spines of the notebook binders (oriented vertically) so that they are maintained substantially parallel to one another, with the spines forming a substantially straight horizontal line oriented parallel with a front edge of the shelf, desk, table or the like. In addition, it has been determined that when stacking binders, it is desirable to arrange the spines (oriented on a horizontal plane) so that they are maintained substantially parallel to one another, with the a line drawn along the spines forming a substantially straight vertical line perpendicular to the plane of the surface upon which the notebook binders are stacked (with the labels comprising the spine all facing in a single direction). It has been further determined that when stacking notebook binders in a box, it is desirable to arrange the spines of the notebook binders (oriented on a horizontal plane) so that labels comprising the spine face out of the box in a manner that they can be readily read. It is believed that particular notebook binder spacer implementations will be desirable from a convenience, aesthetics and marketing standpoint and that it will promote efficiency gains, as well.

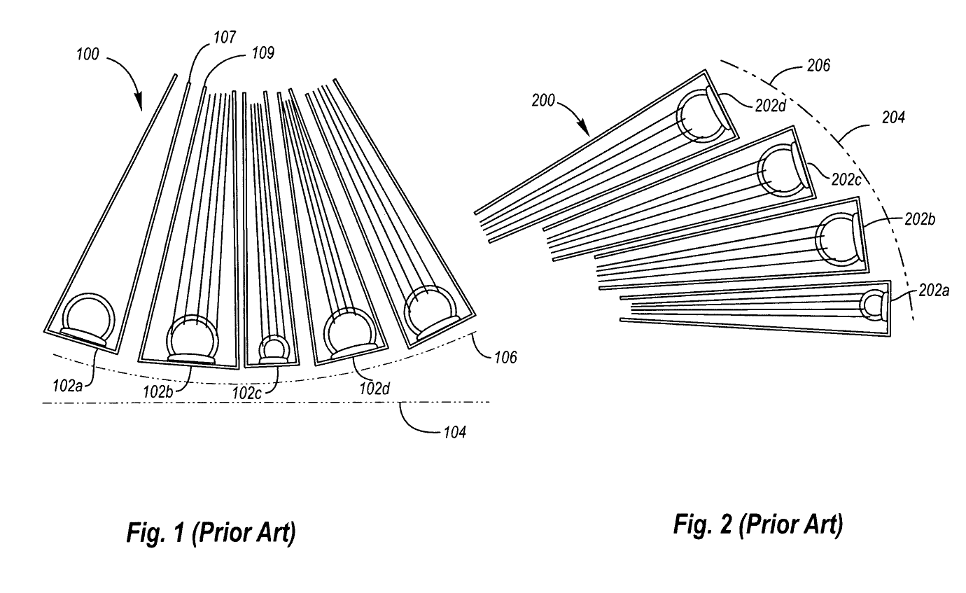

With reference to FIG. 1, a top view of prior art shelved notebook binders is illustrated. When multiple notebook binders 100 are shelved side-by-side on a shelf, desk, table or the like (without spacers), a line 106 drawn along the spines 102 of the notebook binders (oriented vertically) may easily become substantially un-parallel to a horizontal line 104. In particular, the alignment of the spines 102 may form a substantially curvilinear line 106, owing to the wedge-shaped configuration of the binders shelved.

FIG. 2 illustrates an end view of prior art stacked notebook binders. When multiple notebook binders are vertically stacked one on top of another (without spacers), the notebook binders, oriented horizontally, may be difficult to maintain in a neat stack. Specifically, the spines 202 may easily move out of vertical alignment, that is out of a position that is substantially parallel to a vertical line 204. In particular, a line 206 drawn along spines 102 may form a substantially curvilinear line 206, owing to slippage caused when one notebook binder slips down the slope comprising the cover of the notebook binder underneath it.

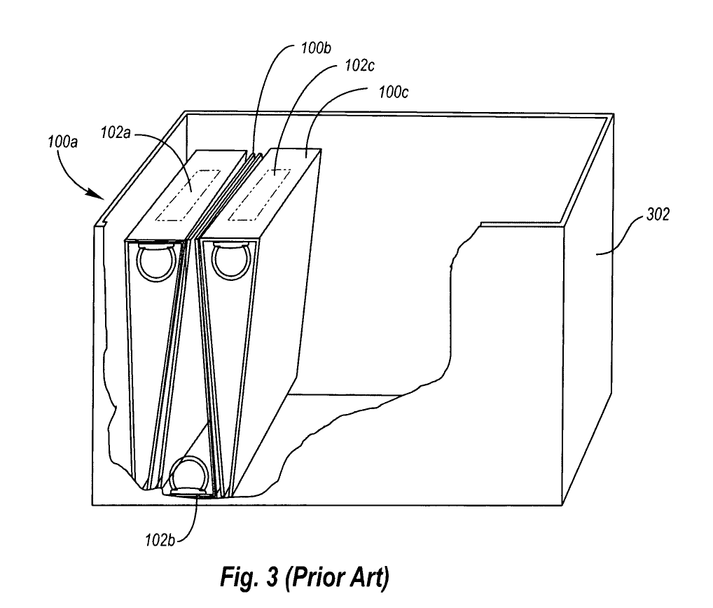

FIG. 3 illustrates a three quarters cut-away view of boxed notebook binders. When more than one notebook binder 100 is stacked side-by-side within a box, carton, or the like in the prior art (without spacers) the spines 102 of the notebook binders are typically alternated between facing upward and facing downward in order to fit more notebook binders 100 within a box. In particular, in the prior art, notebook binder 100a may be positioned so that spine 102a faces skyward. In addition, notebook binder 100b may be positioned so that spine 102b faces downward. The alternation of upward and downward facing spines 102 in adjacent notebook binders 100 may be continued until a box is completely filled or filled to a desired level. Nevertheless, as illustrated, a label that comprises a spine 102 that faces downward may not easily be read by a viewer, and may require a user to physically remove the obscured binder spine 102 from the box 302 for viewing.

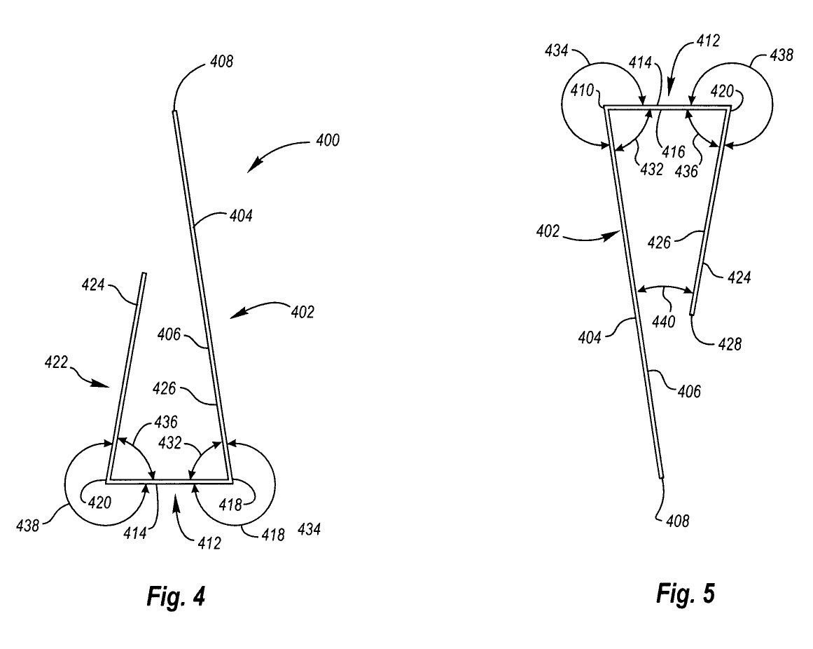

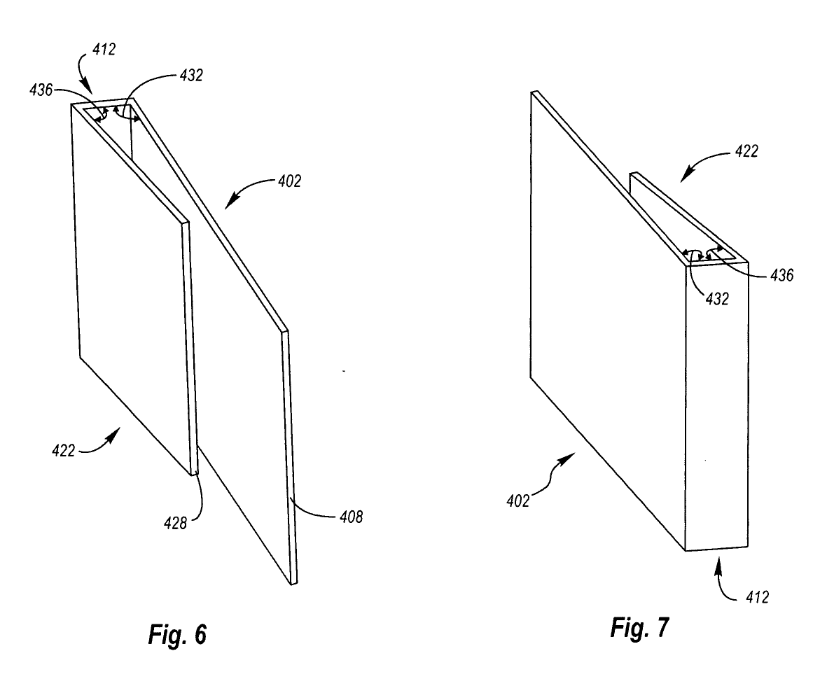

FIGS. 4-7 illustrate various views of a spacer 400 for use with a notebook binder. First panel 402 comprises first panel top edge 410, first panel bottom edge 408, first panel exterior surface 404 and first panel interior surface 406. Second panel 422 comprises second panel top edge 430, second panel bottom edge 428, second panel exterior surface 424 and second panel interior surface 426. End panel 412 comprises end panel top edge 418, end panel bottom edge 420, end panel exterior surface 414 and end panel interior surface 416. First panel top edge 410 may be coupled with (or may be formed integrally with) end panel top edge 420, forming first interior angle 432 and first exterior angle 434. It will be understood that first interior angle 432 and first exterior angle 434 may comprise any supplementary angles, that is, any angles that add up to 180 arc degrees (180°). Nevertheless, in particular implementations, the angle comprising first interior angle 432 may range from about 45° to about 90°. In addition, second panel top edge 430 may be coupled with (or may be formed integrally with) end panel bottom edge 420, forming second interior angle 436 and second exterior angle 438. It will be understood that second interior angle 436 and second exterior angle 438 may comprise any supplementary angles, that is, any angles that add up to 180°. Nevertheless, in particular implementations, the angle comprising second interior angle 436 may range from about 45° to about 90°. In addition, in particular implementations, first panel top edge 410 may be coupled with second panel top edge 430 via an adjustable hinge element. Likewise, in particular implementations, first panel bottom edge 408 may be coupled with a front cover and/or a rear cover of a notebook binder via an adjustable hinge element. It will be understood that adjustable hinge elements may comprise any hinge or similar device configured to couple two solid objects and allow the two solid objects to rotate with respect to one another.

Still referring to FIGS. 4-7, it will be understood that with first panel top edge 410 coupled with end panel top edge 420, and with second panel top edge coupled with (end panel bottom edge 420, a wedge-shaped area may be formed, the wedge-shaped area defined by first panel interior surface 406, second panel interior surface 426, and end panel interior surface 416 and the wedge-shaped area comprising first interior angle 432 and second interior angle 436 (as well as an bottom angle 440, which may be formed by the adjacency of second panel bottom edge 428 to first panel interior surface 406). It will be further understood that, in particular implementations, the angles comprising first interior angle 432, second interior angle 436, and bottom angle 440 may be varied in order to accommodate various notebook binders having varying angles between their covers and their spines. In some implementations, the angles comprising first interior angle 432, second interior angle 436, and bottom angle 440 may be adjustable. In other implementations, the length of second panel 422 may be equal to the length of first panel 402. In still other implementations, the lengths of second panel 422 and first panel 402 may be unequal. In yet other particular implementations, second panel bottom edge 428 may be coupled with first panel interior surface 406. In still other implementations, first panel bottom edge 408 and second panel bottom edge 428 may be coupled.

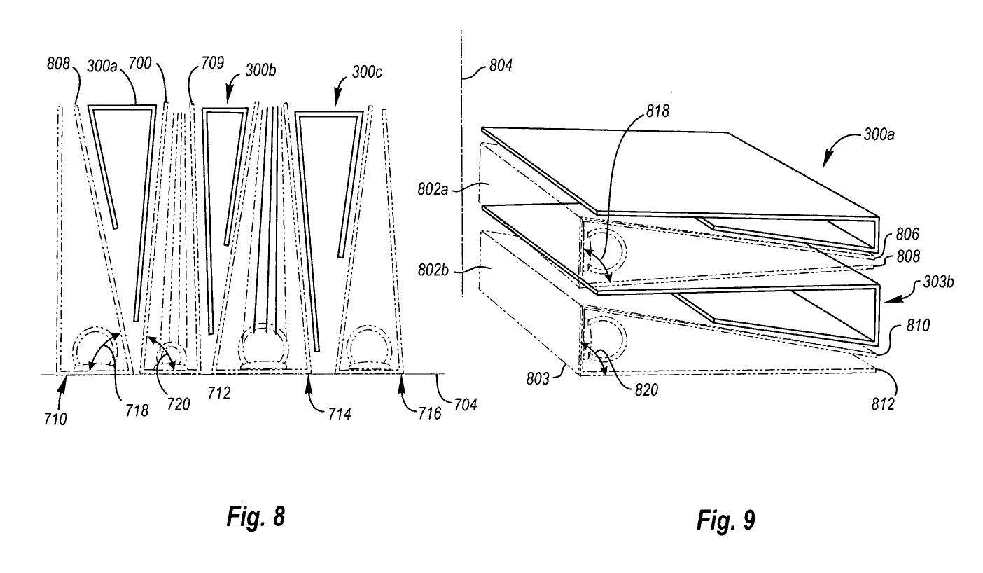

FIG. 8 is an in-use top view of shelved notebook binders (positioned side-by-side) with spacers. As noted supra, when numerous notebook binders are shelved side-by-side without spacers, the spines 102 of the notebook binders (oriented vertically) may be difficult to maintain in a position substantially parallel to a horizontal line 104, and the alignment of the spines 102 may form a substantially curvilinear line 106, owing to the wedge-shaped configuration of the binders (FIG. 1, prior art). By contrast, as can be seen in FIG. 8, when spacers are used in the side-by-side shelving of notebook binders, a user may easily align and maintain the spines 802 of the notebook binders substantially parallel to a horizontal line 804. Specifically, it will be understood that, often times, cover 806 and cover 808 may not be parallel to one another if, for example, there are not many papers or other items contained between cover 806 and cover 808. It will be further understood that when cover 806 is in a non-parallel position with respect to cover 808, the notebook binders may form a wedge-shape. In particular, spine 802 may form the wide part of the wedge, and the convergence of the free ends of cover 806 and 808 (the ends of the cover 806 and 808 not coupled with spine 802) may form the narrow end of the wedge. In order to prevent the splaying of the spines of the notebook binders (FIG. 1, prior art), one or more spacers 300 may be used. In particular, as can be seen in FIG. 8, by inserting a spacer 300 between shelved notebook binder 810 and shelved notebook binder 812, spine 802a of notebook binder 810 and spine 802b of notebook binder 812 may be maintained parallel to horizontal line 804. Specifically, spacer 300 may allow a user to maintain angle 818 between cover 808 and spine 802a and angle 820 between cover 807 and spine 802b so that difference between the angle 820 and angle 818 equals 90°. Stated differently, spacer 300 may allow a user to maintain angle 818 and angle 820 as supplementary angles, that is, so they add up to 180°. It will be understood that by providing a way to supplement angle 818 with respect to angle 820, spines 802 may be easily maintained in a position parallel to horizontal line 804. In addition, it will be understood that by maintaining spines 802 parallel to horizontal line 804, the splaying illustrated in FIG. 1 (with respect to horizontal line 104) may be obviated. It will be further understood that the dimensions of the wedges formed by notebook binders may vary from notebook binder to notebook binder and that, in particular implementations, the angles forming spacer 300 may be varied according to the angles of the wedges presented by various notebook binders. In other implementations, the angles forming spacer 300 may be adjustable in order to allow adjustment according to the angles of the wedges presented by various notebook binders.

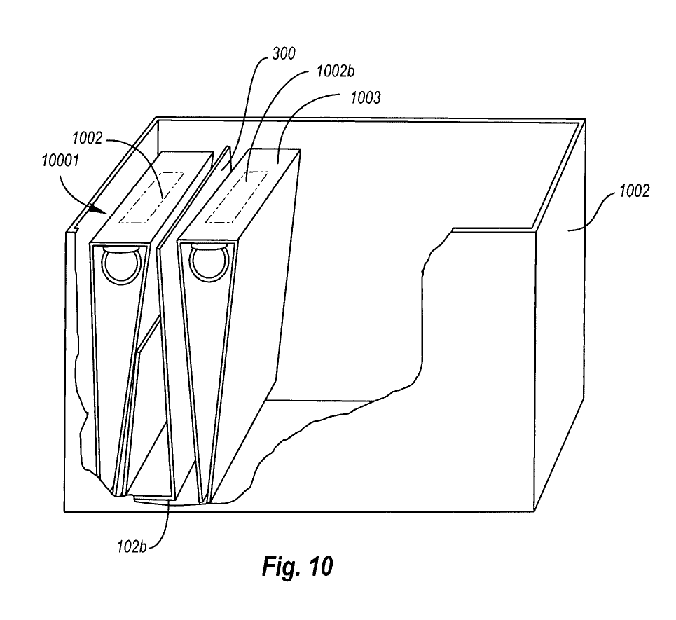

Referring now to FIG. 9, an in-use end view of stacked notebook binders (positioned one on top of another) with spacers is illustrated. As noted supra, when numerous notebook binders are vertically stacked one on top of another without spacers, the notebook binders (themselves oriented horizontally) may be difficult to maintain in a neat stack, and the alignment of the spines 202 may form a substantially curvilinear line 206, owing to slippage caused when one notebook binder slips down the slope comprising the cover of the notebook binder underneath it. (FIG. 2, prior art). By contrast, as can be seen in FIG. 9, when spacers 300 are used in the vertical stacking of notebook binders, a user may easily align and maintain the spines 902 of the notebook binders substantially parallel to a vertical line 904. Specifically, it will be understood that, often times, cover 906 and cover 908 may not be parallel to one another if, for example, there are not many papers or other items contained between cover 906 and cover 908. It will be further understood that when cover 906 is in a non-parallel position with respect to cover 908, the notebook binder may form a wedge-shape. In particular, spine 902 may form the wide part of the wedge, and the convergence of the free ends of cover 906 and 908 (the ends of the cover 906 and 908 not coupled with spine 902) may form the narrow end of the wedge. In order to prevent notebook binder 901 from sliding down the slope formed by cover 910 (shown in FIG. 2, prior art), one or more spacers 300 may be used. In particular, as can be seen in FIG. 9, by inserting a spacer 300 between stacked notebook binder 901 and stacked notebook binder 903, spine 902a of notebook binder 901 and spine 902b of notebook binder 903 may be maintained parallel to vertical line 904 without notebook binder 901 slipping off notebook binder 903. Specifically, spacer 300 may allow a user to maintain angle 918 between cover 908 and spine 902a and angle 920 between cover 910 and spine 902b so that difference between the angle 920 and angle 918 equals 90°. Stated differently, spacer 300 may allow a user to maintain angle 918 and angle 920 as supplementary angles, that is, they add up to 180°. It will be understood that by providing a way to supplement angle 918 with respect to angle 920, spine 902a and spine 902b may be easily maintained in a position parallel to vertical line 904 without binder 901 slipping off binder 903. In addition, it will be understood that by maintaining spine 902a and spine 902b parallel to vertical line 904, the instability illustrated in FIG. 1 (with respect to vertical line 204) may be obviated. It will be further understood that the dimensions of the wedges formed by notebook binders may vary from notebook binder to notebook binder and that, in particular implementations, the angles forming spacer 300 may be varied according to the angles of the wedges presented by various notebook binders. In other implementations, the angles forming spacer 300 may be adjustable in order to allow adjustment according to the angles of the wedges presented by various notebook binders.

FIG. 10 illustrates a cut-away in-use view of boxed notebook binders with spacers. Notebook binders 100 are each boxed with their spines 102 facing outward from the box. Spacers 300 are positioned between each of notebook binders 100 in the box in order to maintain angle 1018 and angle 1020 so that difference between the angle 1020 and angle 1018 equals 90°. Stated differently, spacer 300 may allow a user to maintain angle 1018 and angle 1020 as supplementary angles, that is, they add up to 180°. It will be understood that by providing a way to supplement angle 1018 with respect to angle 1020, spines 1002 may be easily maintained in a position parallel to box end 1004 without notebook binders 100 slipping out of position and without having to alternate the orientation of the spines 1002.

In places where the description above refers to particular implementations of a notebook binder spacer, it should be readily apparent that a number of modifications may be made without departing from the spirit thereof and that these implementations may be applied to other spacers. The accompanying claims are intended to cover such modifications as would fall within the true spirit and scope of the disclosure set forth in this document. The presently disclosed implementations are, therefore, to be considered in all respects as illustrative and not restrictive, the scope of the disclosure being indicated by the appended claims rather than the foregoing description. All changes that come within the meaning of and range of equivalency of the claims are intended to be embraced therein.

1. A spacer for use with a notebook binder, the spacer comprising:
a first panel comprising a top edge, a bottom edge, an exterior surface, and an interior surface;
a second panel comprising a top edge, a bottom edge, an exterior surface, and an interior surface; and
an end panel comprising a top edge, a bottom edge, an exterior surface and an interior surface, wherein:
the top edge of the first panel is coupled with the top edge of the end panel, forming a first interior angle and a first exterior angle;
the top edge of the second panel is coupled with the bottom edge of the end panel, forming a second interior angle and a second exterior angle; and
the interior surfaces of the first panel, second panel and end panel define a wedge-shaped area comprising the first interior angle and second interior angle, wherein the first interior angle and second interior angle are supplementary to the first exterior angle and second exterior angle, respectively.

2. The spacer of claim 1, wherein the first panel of the spacer is coupled with one of a front cover and a rear cover of a notebook binder.

3. The spacer of claim 1, wherein the first panel of the spacer is integral with one of a front cover and a rear cover of a notebook binder.

4. The spacer of claim 1, wherein the second panel of the spacer is coupled with one of a front cover and a rear cover of a notebook binder.

5. The spacer of claim 1, wherein the second panel of the spacer is integral with one of a front cover and a rear cover of a notebook binder.

6. The spacer of claim 1, wherein the bottom edge of the second panel is coupled with the bottom edge of the first panel.

7. The spacer of claim 1, wherein the bottom edge of the second panel is coupled with the interior surface of the first panel.

8. A spacer for use with a notebook binder, the spacer comprising:
a first panel comprising a top edge, a bottom edge, an exterior surface, and an interior surface;
a second panel comprising a top edge, a bottom edge, an exterior surface, and an interior surface; wherein:
the top edge of the first panel is coupled with the top edge of the second panel, forming a first interior angle and a first exterior angle;
the bottom edge of one of the first panel and the second panel is coupled with one of a front cover and a rear cover of a notebook binder, forming a second interior angle and a second exterior angle; and
the interior surfaces of the first panel and the second panel and one of the front cover and the rear cover of the notebook binder define a wedge-shaped area comprising the first interior angle and second interior angle, wherein the first interior angle and second interior angle are supplementary to the first exterior angle and second exterior angle, respectively.

9. The spacer of claim 8, wherein the top edge of the first panel is coupled with the top edge of the second panel via a hinge element.

10. The spacer of claim 8, the bottom edge of the first panel is coupled with one of a front cover and a rear cover of a notebook binder via a hinge element.

11. The spacer of claim 8, wherein the bottom edge of the second panel is coupled with one of the front cover and the rear cover of the notebook binder.

12. A method of vertically or horizontally stacking notebook binders using a spacer, the method comprising:
placing a first notebook binder on one of a front cover, a rear cover, a top end, a bottom end, a front edge, and a spine;
placing one of a first panel and a second panel of a spacer in communication with one of the front cover, the rear cover, the top end, the bottom end, the front edge, and the spine of the first notebook binder; and
placing a second notebook binder, different from the first notebook binder, on one of a front cover, a rear cover, a top end, a bottom end, a front edge, and a spine, so that one of the front cover and the rear cover of the second notebook binder is in communication with one of the first panel and the second panel of the spacer.

13. The method of claim 12, wherein placing one of a first panel and a second panel of a spacer in communication with one of the front cover, the rear cover, the top end and the bottom end of the first notebook spacer comprises first adjusting an area between the first panel and the second panel of the spacer.
